(19) United States
(12) Patent Application Publication
(10) Pub. No.: US 2010/0309616 A1
(43) Pub. Date: Dec. 9, 2010

(54) MONITOR PANEL DEVICE

(76) Inventors: Kimihisa Miura, Tokyo (JP); Yuki Matsumoto, Hyogo (JP)

Correspondence Address: BIRCH STEWART KOLASCH & BIRCH, PO BOX 747, FALLS CHURCH, VA, 22040-0747, US

(21) Appl. No.: 12/744,087

(22) PCT Filed: Nov. 12, 2008
(86) PCT No.: PCT/JP2008/003295

§ 371 Date: May 21, 2010

(30) Foreign Application Priority Data
Jan. 16, 2008 (JP) 2008-006880

(51) Int. Cl. H05K 7/00

(52) U.S. Cl. 361/679.01

(57) ABSTRACT

A monitor panel device has a structure in which guide pins 8 provided on opposite side faces of a liquid crystal monitor panel 7 are fitted in guide grooves 9 provided at right and left in the front of a sub-panel 3 forming part of a device body, wherein plates 11a and 11b each are slid to expose or cover opening 9a at the lower end of the guide groove 9 and are mounted to the front face of the sub-panel 3 to prevent falling out of the sub-panel 3.

### TECHNICAL FIELD

The present invention relates to a monitor panel device that facilitates mounting of a monitor panel thereto.

### BACKGROUND ART

Monitor panel devices having a liquid crystal monitor panel or the like include a monitor panel device where a liquid crystal monitor panel is movable relative to a body portion of the monitor panel device such as a vehicle navigation system. An example of such a monitor panel device is illustrated in FIG. 13 and FIG. 14. In FIGS. 13 and 14, a device body 101 is composed of a casing 102 and a sub-panel 103 at the front face of the casing. Various appliances and/or a drive such as a CD and a CD-ROM are built in the casing 102. A concave monitor-panel-housing section 104 is provided on the front side of the sub-panel 103, and a loading slot (not shown) for inserting a CD, a CD-ROM or the like is formed at the front of the sub-panel 103 in the monitor-panel-housing section 104. A right plate section 105a and a left plate section 105b arranged by operating buttons and so on are formed on opposite sides of the monitor-panel-housing section 104, respectively.

A liquid crystal monitor panel (monitor panel) 106 is tiltably housed in the monitor-panel-housing section 104 of the sub-panel 103. The monitor panel 106 has a guide pin 107 provided in the vicinity of the upper portion of each of opposite side faces thereof. On the other hand, a guide groove 108 for receiving the guide pin 107 is formed on the inner side of each of the right plate section 105a and the left plate section 105b. A slide mechanism built in the casing 102 is coupled to the lower portion of each of the opposite side faces of the monitor panel 106. The lower portion of the monitor panel 106 is forwardly pushed out by the slide mechanism to move the guide pin 107 along the guide groove 108, resulting in tiltingly moving the monitor panel 106 from the state shown in FIG. 13 to that shown in FIG. 14.

In the above-described monitor panel device, when the guide pins 107 of the monitor panel 106 are mounted to the guide grooves 108, if the monitor panel 106 remains in a horizontal attitude, the guide pin 107 and the right and left plate sections 105a and 105b can interfere with each other, and the monitor panel cannot be inserted within the monitor-panel-housing section 104. Thus, the monitor panel 106 is inclined to insert the monitor panel in the monitor-panel-housing section 104 and then the guide pins 107 are fitted in the guide grooves 108. However, the guide pins 107 strike the plate sections 105a and 105b, and further the monitor panel 106 strikes the plate sections 105a and 105b, resulting in scratching the monitor panel 106 and the plate sections 105a and 105b.

In view of this matter, a monitor panel device is contrived in which the portion corresponding to the lower end portion of the guide groove 108 in each of the plate sections 105a and 105b is produced as a separate member that can be removed. When the guide pin 107 of the monitor panel 106 is inserted in the guide groove 108, the separate member is detached to expose the lower end of the guide groove 108. However, in the production of such a monitor panel device, the sub-panel 103 and the removable separate member are separately produced for reasons on production and coating lots are different therebetween, thus making a difference in color tone and deteriorating the appearance thereof. Further, in assembly and reassembly thereof, the separate members are detached and reattached, and at that time, the separate members, the sub-panel 103, and the monitor panel 106 can be scratched. Structures for mounting a monitor panel on a device body include a structure disclosed in Patent Document 1, for example.

Patent Document 1: JP-A-03-106098 (JP-A-1991-106098)

The present invention has been made to solve the above-mentioned problems in conventional monitor panel devices, and an object of the present invention is to facilitate mounting of a liquid crystal monitor panel or the like to guide grooves, and also to prevent the occurrence of a difference in color tone due to forming part of a sub-panel forming a body of a monitor panel device as a separate member, and further to prevent the occurrence of scratches when the monitor panel is attached to and detached from the body.

### DISCLOSURE OF THE INVENTION

The monitor panel device of the present invention has a structure in which guide grooves each opened at the front face of a device body are provided at right and left in the front of the device body, guide pins arranged on opposite sides of a monitor panel are fitted in the guide grooves, respectively, and the monitor panel is displaced tiltingly relative to the device body such that the guide pins are guided along the guide grooves, wherein a plate is displaced to expose or cover the end of the guide groove and is mounted to the front face of the device body to prevent falling out of the device body.

According to the monitor panel device of the present invention, since the end of the guide groove is exposed due to displacement of the plate, mounting of the guide pin of the monitor panel to the guide groove is facilitated to eliminate occurrence of scratches to the device body. Also, since the plate is coated in a state to be mounted to the device body, there is no occurrence of a difference in color tone in the device body.

### BRIEF DESCRIPTION OF THE DRAWINGS

FIG. 1 is an perspective view of a device body of a monitor panel device in a first embodiment of the present invention.

FIG. 2 is an perspective view of the state where a monitor panel is mounted to the device body of the monitor panel device in the first embodiment of the present invention.

FIG. 3 is an enlarged view of the “III” portion in FIG. 2.

FIG. 4 is a perspective view of a mounted structure of a plate in the first embodiment.

FIG. 5 is a perspective view of the state where the plate is removed from a sub-panel in FIG. 4.

FIG. 6 is a perspective view partially omitted and illustrating the back face of the plate and the front face of the sub-panel shown in FIG. 4.

FIG. 7 is a perspective view of a device body of a monitor panel device in a second embodiment of the present invention.

FIG. 8 is a perspective view showing a state where a monitor panel is mounted to the device body of the monitor panel device in the second embodiment of the present invention.

FIG. 9 is a perspective view of a mounted structure of a plate in the second embodiment.

FIG. 10 is a perspective view of a state where the plate is removed from a sub-panel in FIG. 9.

FIG. 11 is a perspective view of the back face of the plate in FIG. 9.

FIG. 12 is a sectional view taken along the plane of the plate in the state in FIG. 9.

FIG. 13 is a perspective view of a basic monitor panel device.

FIG. 14 is a perspective view of a state where a monitor panel is inclined in the monitor panel device shown in FIG. 13.

### BEST MODE FOR CARRYING OUT THE INVENTION

Embodiments of the present invention will now be described with reference to the accompanying drawings in order to explain the present invention in more detail.

### First Embodiment

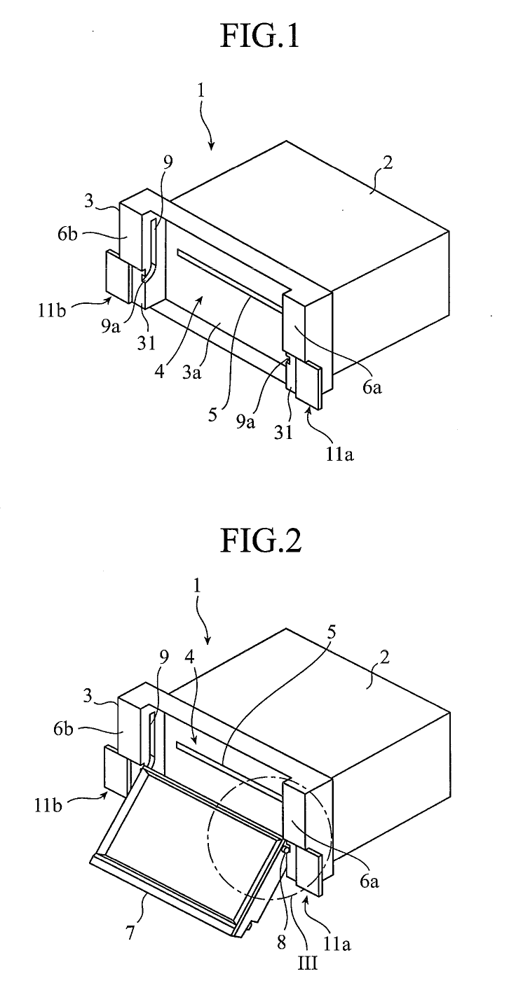

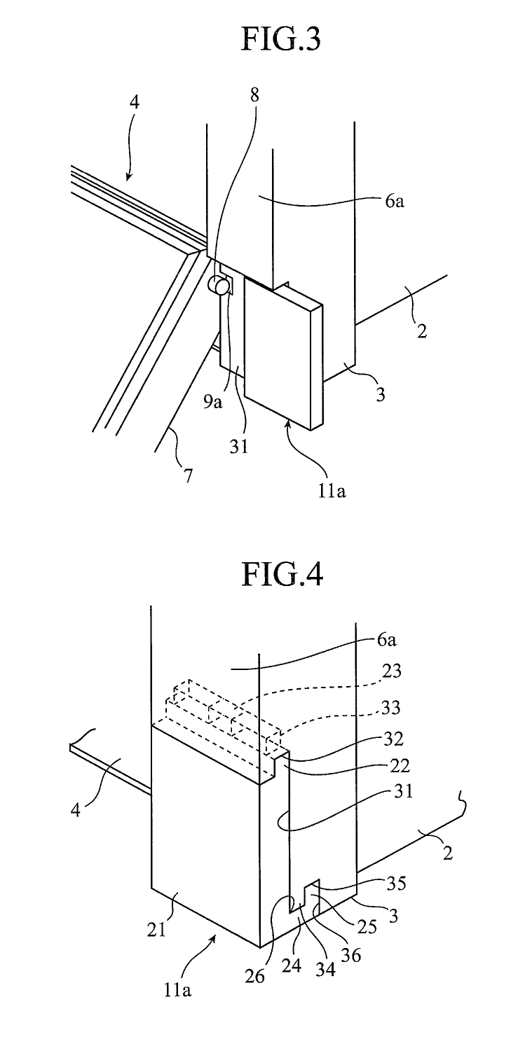

FIG. 1 is a perspective view of a device body of a monitor panel device in accordance with the first embodiment, FIG. 2 is a perspective view of a state where a liquid crystal monitor panel is mounted to the device body shown in FIG. 1, and FIG. 3 is an enlarged view of the “III” portion in FIG. 2.

A device body 1 is composed of a casing 2 and a sub-panel 3 forming the front face of the device body. Various appliances and a drive of a CD and a CD-ROM, or the like are built in the casing 2. A concave monitor-panel-housing section 4 is provided on the front side of the sub-panel 3, and a CD-loading slot 5 for inserting a CD, a CD-ROM or the like is formed at the front face 3a of the sub-panel 3. Button arrangement portions 6a (right side) and 6b (left side) to be arranged by operation buttons and the like on the two sides, right and left of the monitor-panel-housing section 4.

A liquid crystal monitor panel (monitor panel) 7 is tiltably housed in the monitor-panel-housing section 4 of the sub-panel 3. Guide pins (monitor panel pin) 8 are provided in the vicinity of the upper portions on opposite sides of the monitor panel 7. On the other hand, guide grooves (cam groove) 9 to be inserted by the guide pin 8 are provided on the inner sides of the right and left button arrangement portions 6a and 6b. A slide mechanism installed within the casing 2 is coupled to the lower portion of each of opposite sides of the monitor panel 7. The guide groove 9 is curved toward the front side of the button arrangement portions 6a and 6b at the lower portion thereof, and openings 9a opened at the front face of the button arrangement portions 6a and 6b are formed at the lower end of the guide groove. Therefore, as the movement of the monitor panel is not depicted, when the guide pin 8 of the monitor panel 7 is inserted into the guide groove 9 and then the monitor panel 7 is pushed upwardly until the guide pin 8 arrives at the top portion of the guide groove 9, the monitor panel 7 is vertically disposed and is housed in the monitor-panel-housing section 4. In such a state, the monitor panel 7 is displaced at the front of the CD-loading slot 5, which comes to cover the slot 5. When the lower portion of the monitor panel 7 is pushed out forwardly by means of the above-described slide mechanism, the guide pin 8 is moved along the guide groove 9 and the monitor panel 7 is tilted to disclose the CD-loading slot 5.

Plates 11a and 11b as a moving feature are provided slidably in a lateral direction at the lower portions of the button arrangement portions 6a and 6b in the sub-panel 3, respectively. These plates 11a and 11b are regulated in a sliding range, and are mounted to the sub-panel 3 to prevent falling out thereof. The opening 9a in the lower end of the guide groove 9 is exposed by the movement outward in the lateral direction of each of the plates 11a and 11b. When the plates 11a and 11b are inwardly moved in a lateral direction to be in a closed state, the opening 9a at the lower end of the guide groove 9 is closed.

FIGS. 4, 5, and 6 illustrate the details of the slide mechanisms of the right and left plates 11a and 11b. The right plate 11a and the left plate 11b have the same structure except for the bilaterally-symmetric portions thereof, and thus the structure of the right plate 11a will be discussed hereinafter. It is noted that the plates 11a and 11b are formed of plastic as with the sub-panel 3.

A slide section 22 of which the thickness is smaller than that of the body section 21 is provided with a shoulder on the top face of a body section 21 in the form of a rectangular plate of the plate 11a. A stopper section 23 is convexly provided in the central portion on the top face of the slide section 22. A connection section 24 and a regulation section 25 is provided with being bent toward the back side at the lower portion of the body section 21 (toward the side of the sub-panel 3), and a groove 26 is formed between the connection section 24 and the regulation section 25. The slide section 22, the connection section 24, and the regulation section 25 each are equal to the body section 21 in length in the lateral direction. A regulation convexity 27 is provided in the vicinity of the end on the back side of the regulation section 25. In the right plate 11a, the regulation convexity 27 is disposed in the vicinity of the end on the left side in a mounted state (viewed from the front), while in the left plate 11b, the convexity is disposed symmetrically thereto, that is, in the vicinity of the end on the right side thereof.

A cutout 31 for mounting the plate 11a thereto is formed on the front face at the lower portion of the sub-panel 3. The opening 9a at the lower end of the guide groove 9 is opened in the cutout 31. A slide groove 32 in which the slide section 22 of the plate 11a is fitted is formed at the upper portion of the cutout 31. A stopper-section-regulating groove 33 is formed to be connected with the upper portion of the slide groove 32. The stopper section 23 at the upper portion of the plate 11a is fitted in the stopper-section-regulating groove 33.

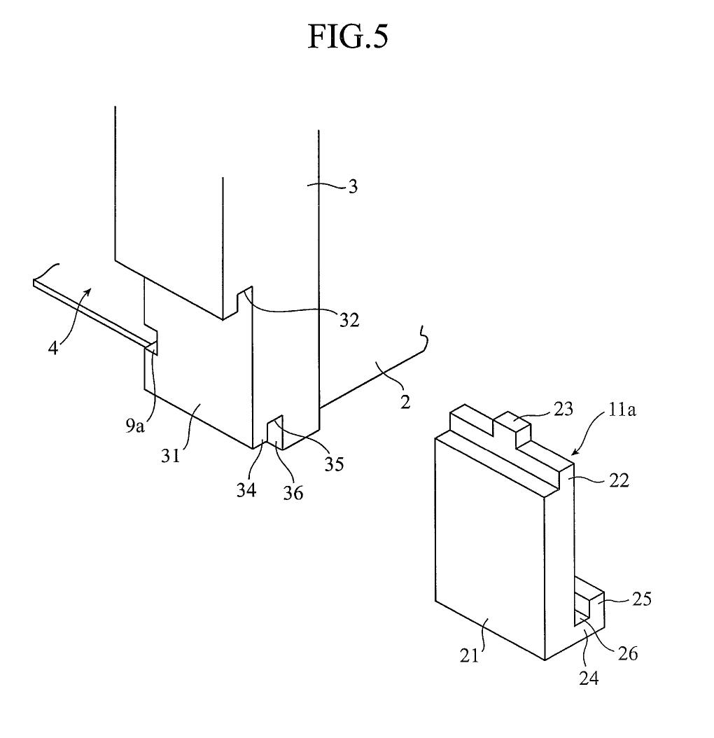

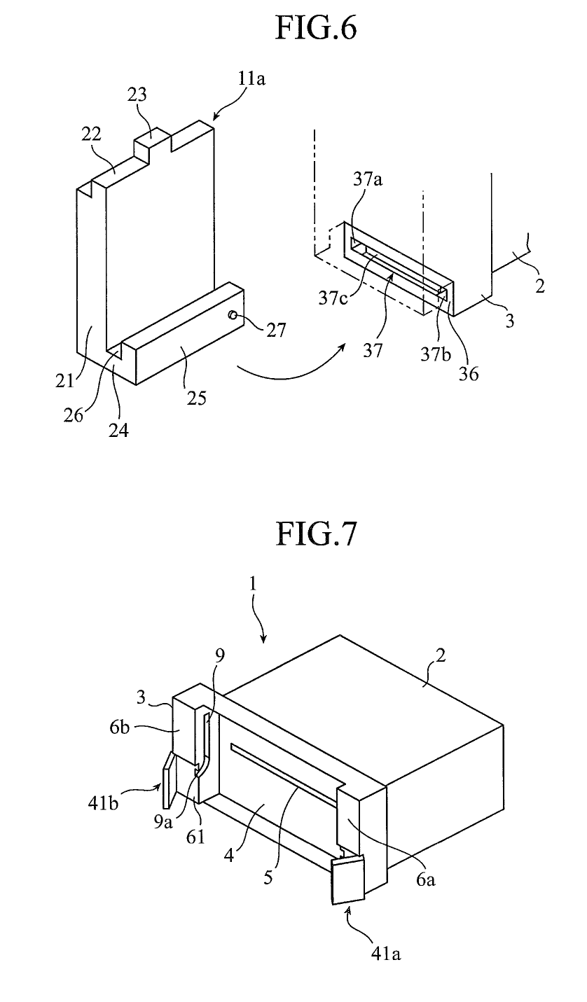

A structure in which the connection section 24 and the regulation section 25 at the lower portion of the plate 11a are fitted is provided at the lower end portion of the sub-panel 3. In other words, as shown in FIGS. 4 and 5, a convexity 34 fitted in the groove 26 is formed, and also a regulation-section receiving groove 35 in which the regulation section 25 is fitted is formed. At a front-facing face 36 forming the regulation-section receiving groove 35, as shown in FIG. 6, a regulation groove 37 in which the aforementioned regulation convexity 27 is fitted is formed in a lateral direction. Lock grooves 37a and 37b each having a deep depth are at both end portions of the regulation groove 37, and a travel guide 37c having a shallow depth is provided between the lock grooves 37a and 37b.

As shown in FIG. 4, in a state where the plate 11a is mounted to the cutout 31 of the sub-panel 3, the slide section 22 at the upper portion of the plate 11a is fitted in the slide groove 32 on the side of the sub-panel 3, the stopper section 23 on the slide section 22 is fitted in the stopper-section-regulating groove 33, the groove 26 formed at the lower portion of the plate 11a is fitted along the convexity 34, and the regulation section 25 is fitted in the regulation-section receiving groove 35. Further, the regulation convexity 27 provided in the vicinity of one end of the regulation section 25 is fitted in the lock groove 37a on the inner side of the regulation groove 37. Under such a condition, if an external force is not exerted on the plate 11a, the plate 11a does not downwardly fall out of the sub-panel 3 nor laterally slide, since the regulation convexity 27 is fitted in the lock groove 37a of the regulation groove 37. It should be appreciated that the regulation convexity 27 and the regulation groove 37 may be disposed at any place on the mating surfaces between the plate 11a and the sub-panel 3.

A coating and so on are is applied to the sub-panel 3 in a state that the plate 41a is mounted thereto as shown in FIG. 4. Therefore, there is no occurrence of a difference in color tone between the button arrangement portion 6a of the sub-panel 3 and the plate 11a.

In such a monitor panel device, when the monitor panel 7 is mounted to the sub-panel 3 on the side of the device body 1, first, the right panel 11a and the left plate 11b are outwardly moved in a lateral direction. By exerting a force having some degree of strength outward in the lateral direction on the plates 11a and 11b, each of the regulation convexities 27 gets on the travel guide 37c from the lock groove 37a, and thereby, the plates 11a and 11b come to be slidable outwardly in the lateral direction. The plates 11a and 11b are formed of plastic with resilience, which enables such an operation. The plate 11a displaced outwardly in the lateral direction is stopped such that the stopper section 23 on the upper portion thereof the abuts against the end of the stopper-section-regulating groove 33. Under such a condition, the opening 9a at the lower end of the guide groove 9 in the cutout 31 of the sub-panel 3 is exposed. Accordingly, the guide pins 8 on opposite sides of the monitor panel 7 can be easily inserted into the respective guide grooves 9. After insertion of the guide pin 8 into the guide groove 9, the plates 11a and 11b are inwardly slid in the lateral direction and moved to be returned to the former positions. Each of the regulation convexities 27 is fitted in the lock groove 37a of the regulation groove 37, and thereby the plates 11a and 11b is placed in a unmoving state. Therefore, even if a force is laterally exerted on the plates 11a and 11b by mistake, the plates are not easily moved. It is noted that a slide mechanism (not shown) within the casing 2 for tilting the monitor panel 7 is connected to the lower portions on the opposite sides of the monitor panel 7.

According to the monitor panel device in accordance with the first embodiment, since a coating is applied to the device in a state that the plates 11a and 11b are mounted thereto, there is no occurrence of a difference in color tone between the button arrangement portions 6a and 6b in the sub-panel 3 and the plates 11a and 11b. Further, owing to a manner to slide the plates 11a and 11b, the guide pins 8 of the monitor panel 7 can be easily inserted in the guide grooves 9 to thus avoid striking of the guide pin 8 on the sub-panel 3, not scratching the sub-panel 3. Furthermore, the plates 11a and 11b do not fall out of the sub-panel 3, and thus the integration of the plates with the sub-panel 3 is not impaired. In other words, there is no occurrence such that when the plates 11a and 11b fall out of the sub-panel 3, and another plate is mounted thereto instead, which renders a combination different from that upon the coating to thus effect a difference in color tone.

### Second Embodiment

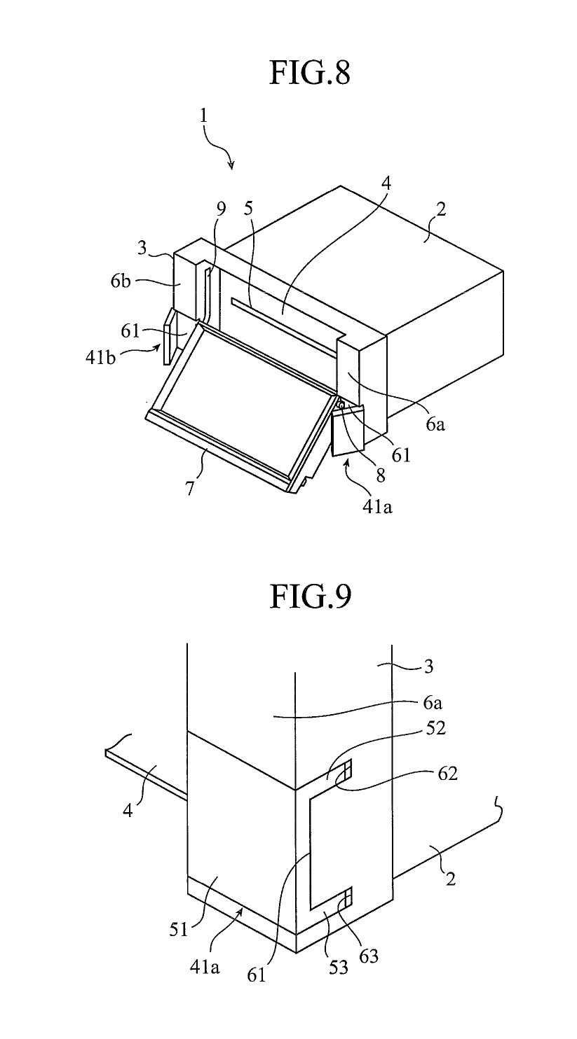

FIG. 7 is an perspective view of a device body in a monitor panel device in accordance with the second embodiment, and FIG. 8 is an perspective view of a state where a liquid crystal monitor panel is mounted to the device body illustrated in FIG. 7.

The structure of a device body 1 is the same as that of the monitor panel device of the first embodiment. That is, the device body 1 is composed of a casing 2 and a sub-panel 3 forming the front face thereof. Various appliances and/or a drive of a CD and a CD-ROM, or the like are built in the casing 2. A concave monitor-panel-housing section 4 is provided on the front side of the sub-panel 3, and a CD loading slot 5 for inserting a CD, a CD-ROM or the like are formed in the front face of the sub-panel 3 corresponding to the bottom of the monitor-panel-housing section 4. Button arrangement portions 6a and 6b where operation buttons and so on are arranged on opposite sides of the monitor-panel-housing section 4.

A liquid crystal monitor panel (monitor panel) 7 is tiltably housed in the monitor-panel-housing section 4 of the sub-panel 3. Guide pins (monitor panel pins) 8 are provided in the vicinity of the upper portions of opposite sides of the monitor panel 7. On the other hand, a guide groove (cam groove) 9 for receiving the guide pin 8 therein is provided on the inner side of each of the right and the left button arrangement portions 6a and 6b. A slide mechanism built in the casing 2 is coupled to the lower portions of the opposite sides of the monitor panel 7. The guide groove 9 is curved toward the front side of each of the button arrangement portions 6a and 6b at the lower portion thereof, and an opening 9a opened at the front face of each of the button arrangement portions 6a and 6b is formed at the lower end of the guide groove. Therefore, as the movement of the monitor panel is not depicted, when the guide pin 8 of the monitor panel 7 is inserted into the guide groove 9 and then the monitor panel 7 is pressed upwardly until the guide pin 8 arrives at the top portion of the guide groove 9, the monitor panel 7 is vertically disposed and is housed in the monitor-panel-housing section 4. In such a state, the monitor panel 7 is displaced at the front of the CD-loading slot 5, which comes to cover the CD-loading slot 5. When the lower portion of the monitor panel 7 is pushed out forwardly by the above-described slide mechanism, the guide pin 8 is moved along the guide groove 9 and the monitor panel 7 is tilted to disclose the CD-loading slot 5.

In the monitor panel device of the second embodiment, plates 41a and 41b are pivotally fit to be rotatable as a moving feature at the lower portions of the button arrangement portions 6a and 6b in the sub-panel 3 respectively. Those plates 41a and 41b each have a regulated range of rotation, and are mounted to the sub-panel 3 so as not to fall out thereof. The opening 9a in the lower end of the guide groove 9 is exposed by the rotation outward in the lateral direction of the plates 41a and 41b. When the plates 41a and 41b are inwardly rotated in the lateral direction to be placed in a closed state, the opening 9a of the guide groove 9 is closed.

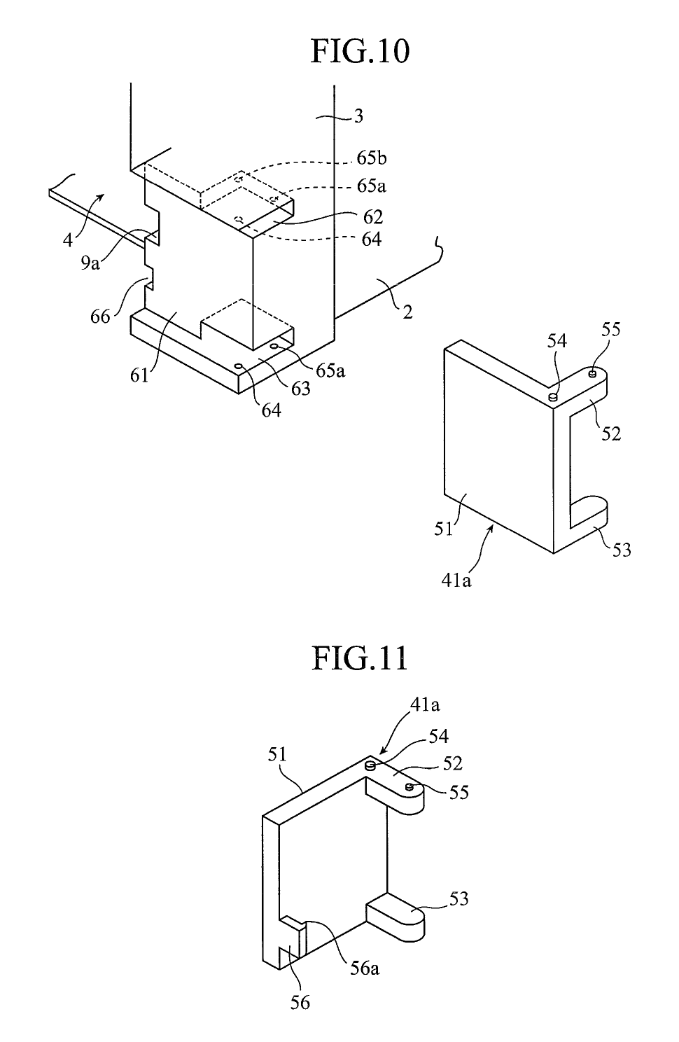

FIGS. 9 to 12 illustrate the details of a rotation mechanism of the right and left plates 41a and 41b. The right plate 41a and the left plate 41b have the same structure except for the bilaterally-symmetric portions thereof, and thus the structure of the right plate 41a will be discussed hereinlater. It is noted that the plates 41a and 41b are formed of plastic as with the sub-panel 3.

The plate 41a has hinge sections 52 and 53 provided in the upper portion and the lower portion, respectively, at the end (the right end of the right plate 41a and the left end of the left plate 41b) of one face of a rectangular-plate-shaped body section 51 thereof. Shafts 54 are protrusively provided on the top face of the upper hinge section 52 and on the bottom face of the lower hinge section 53, respectively. Further, a position-regulating protrusion 55 is provided on the same face. As the shaft 54 and the position-regulating protrusion 55 on the bottom face of the lower hinge section 53 are not depicted in the figure, the shaft and protrusion also are disposed in a similar configuration to the top face of the upper hinge section 52. A hook 56 is provided at the end on the side of the body section 51 opposite the side thereof where the hinge sections 52 and 53 are provided. A pawl 56a is formed at the tip of the hook 56.

A cutout 61 having a shape similar to that of the body section 51 and used for assembling the plate 41a is formed at the front of the lower portion of the sub-panel 3. The opening 9a at the lower end of the guide groove 9 is opened in the cutout 61. Rectangular hinge-receiving concavities 62 and 63 for housing the hinge sections 52 and 53 of the plate 41a are formed at the upper and lower portions of the corner located outward in the lateral direction of the cutout 61, respectively. A shaft holding hole 64 in which the shaft 54 of the plate 41a is fitted, and position-regulating holes 65a and 65b in which the position-regulating protrusion 55 is fitted are formed on the ceiling of the upper hinge-receiving concavity 62, and the bottom of the lower hinge-receiving concavity 63, respectively. A hook-engaging groove 66 is formed on the lower side of the opening 9a at the lower end of the guide groove 9 in the cutout 61 of the sub-panel 3, and an engaging section 66a that can engage with the pawl 56a of the hook 56 is formed in the engaging groove 66.

As shown in FIG. 9, in a state where the plate 41a is mounted to the cutout 61 of the sub-panel 3, the hinge sections 52 and 53 at the upper and lower portions of the corner of the plate 41a are fitted in the hinge-receiving concavities 62 and 63, respectively, and the shafts 54 of the hinge sections 52 and 53 are fitted in the shaft-holding holes 64. Further, the position-regulating protrusions 55 are fitted in the position-regulating holes 65a on one side. Moreover, the hook 56 enters the hook-engaging groove 66, and the pawl 56a engages with the engaging section 66a. Therefore, the plates 41a and 41b are not rotated unless a force having some degree of strength is exerted on the plates, and also the plates do not fall out of the sub-panel 3.

A coating and so on are is applied to the sub-panel 3 in a state that the plate 41a is mounted thereto as shown in FIG. 9. Therefore, there is no occurrence of a difference in color tone between the button arrangement portion 6a of the sub-panel 3 and the plate 11a.

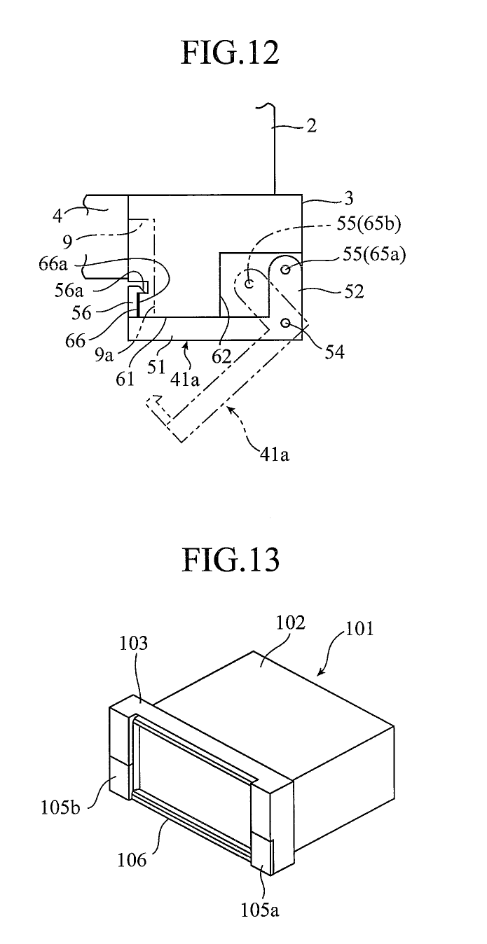

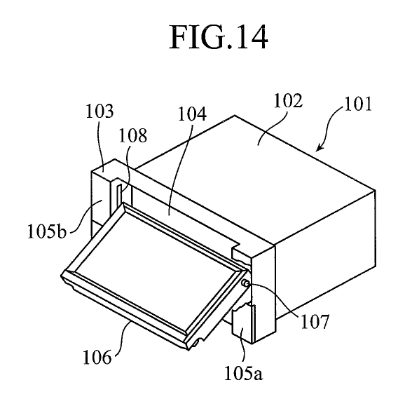

In such a monitor panel device, when the monitor panel 7 is mounted to the sub-panel 3 on the side of the device body 1, first, the right plate 41a and the left plate 41b are rotated outwardly in the lateral direction. When a force having some degree of strength is exerted on the inner ends of the plates 41a and 41b in such a manner as to draw the plates toward the front, the pawl 56a of the hook 56 is disengaged from the engaging section 66a of the hook-engaging groove 66 on the side of the sub-panel 3, and also the position-regulating protrusion 55 is disengaged from the position-regulating hole 65a to thereby rotate the plate 41a. When the plate 41a is rotated, and the position-regulating protrusion 55 is fitted in another position-regulating hole 65b as illustrated by the dash-double-dot lines in FIG. 12, the plate is stopped. The plates 41a and 41b are formed of plastic with resilience, which enables such an operation. When the plate 41a is rotated in this manner, the opening 9a located at the lower end of the guide groove 9 and opened in the cutout 61 of the sub-panel 3 is exposed under such a condition. Therefore, the guide pins 8 on opposite sides of the monitor panel 7 can be easily inserted into the respective guide grooves 9 to thus prevent striking of the guide pins 8 on the sub-panel 3, not scratching the sub-panel 3. After insertion of the guide pin 8 into the guide groove 9, when the plates 41a and 41b are rotated inwardly in the lateral direction to be returned to the original position, the position-regulating protrusions 55 are fitted in the position-regulating holes 65a, and further the pawl 56a of the hook 56 is engaged with the engaging section 66a of the hook-engaging groove 66 to thus achieve a unmoving state of the plates 41a and 41b. Therefore, even if a slight force is exerted on the plates 41a and 41b by mistake, the plates 41a and 41b are not easily moved.

In accordance with the monitor panel device of the second embodiment, since a coating is applied to the device in a state that the plates 41a and 41b are mounted thereto, there is no occurrence of a difference in color tone between the button arrangement portions 6a and 6b in the sub-panel 3 and the plates 41a and 41b. Also, when the plates 41a and 41b are rotated, the opening 9a at the lower end of the guide groove 9 is exposed, and thus the guide pins 8 of the monitor panel 7 can be easily inserted into the respective guide grooves 9. Further, the plates 41a and 41b do not easily fall out of the sub-panel 3, and thus the integration of the plates with the sub-panel 3 is not impaired. In other words, there is no occurrence such that when the plates 41a and 41b fall out of the sub-panel 3, and another plate is mounted thereto instead, which renders a combination different from that upon the coating to thus effect a difference in color tone.

It should be understood that the above-discussed first and second embodiments are shown by way of illustrations of the embodiments of the present invention, and various structures in which a plate mounted to a sub-panel can be moved and thereby the lower end of a guide groove is exposed are contemplated in addition to the discussed structures.

### INDUSTRIAL APPLICABILITY

As discussed above, the monitor panel device of the present invention is arranged to have a structure in which guide grooves each opened at the front face of a device body are provided at right and left in the front of the device body, guide pins disposed on opposite side faces of a monitor panel are fitted in the guide grooves, respectively, and the monitor panel is displaced tiltingly relative to the device body such that the guide pins are guided along the guide grooves, wherein plates each are displaced to expose or cover the end of the guide groove and are mounted on the front face of the device body so as not to fall out of the device body. Thus, the end of the guide groove is exposed by displacement of the plate, mounting of the guide pins of the monitor panel to the guide grooves is thereby facilitated, not scratching the body of the device. Further, since the plate is coated in a state mounted to the device body, there is no occurrence of a difference in color tone in the device body; thus, the monitor panel device is suitable for use in, e.g., monitor panel devices including a liquid crystal monitor panel and the like.

1. A monitor panel device having a structure in which guide grooves each opened at the front face of a device body are provided at right and left in the front of the device body, guide pins arranged on opposite sides of a monitor panel are fitted in the guide grooves, respectively, and the monitor panel is displaced tiltingly relative to the device body such that the guide pins are guided by the guide grooves, wherein a plate is displaced to expose or cover the end of the guide groove and is mounted to the front face of the device body to prevent falling out of the device body.

2. The monitor panel device according to claim 1, wherein the plate is provided slidably in a lateral direction on the front face of the device body, and a mechanism for preventing the plate from falling out of the device body and for regulating a sliding range thereof is provided between the plate and the device body.

3. The monitor panel device according to claim 1, wherein the plate is pivotally fit to be rotatable at the front face of the device body, and the end of the guide groove is exposed when the plate is rotated and opened, while the end thereof is covered when the plate is closed.
